(19) United States
(12) Patent Application Publication
(10) Pub. No.: US 2025/0305619 A1
(43) Pub. Date: Oct. 2, 2025

(54) PIPELINE INSPECTION DEVICE WITH USER INTERFACE

(71) Applicant: MILWAUKEE ELECTRIC TOOL CORPORATION, Brookfield, WI (US)

(72) Inventor: Joseph D. Kotlan, Menomonee Falls, WI (US)

(21) Appl. No.: 19/092,208

(22) Filed: Mar. 27, 2025

Related U.S. Application Data
(60) Provisional application No. 63/571,285, filed on Mar. 28, 2024.

(51) Int. Cl. F16L 55/48; F16L 55/30; F16L 55/40; F16L 101/30; F17D 5/06; G01N 21/954

(52) U.S. Cl. CPC F16L 55/48; F16L 55/30; F16L 55/40; F17D 5/06; F16L 2101/30; G01N 21/954

(57) ABSTRACT

An inspection system, the system comprising a cable. The cable includes an image capture device positioned at a distal end of the cable and a monitoring device. The image capture device is configured to output digital data. The monitoring device includes a housing including a removable first handle and a removable second handle, a display configured to display images captured by the image capture device in response to receiving the received digital data, and a user interface overlaid over the displayed images, the user interface including touchscreen icons.

### CROSS REFERENCE TO RELATED APPLICATIONS

This application claims priority to U.S. Provisional Patent Application No. 63/571,285, filed Mar. 28, 2024, the entire contents of which are incorporated by reference herein.

### FIELD OF THE INVENTION

The present invention relates to inspection devices for inspecting sewers, drains, pipes, or other conduits, and to user interfaces for the inspection devices.

### SUMMARY

In one aspect, the disclosure provides an inspection system, the system comprising a cable. The cable includes an image capture device positioned at a distal end of the cable and a monitoring device. The image capture device is configured to output digital data. The monitoring device includes a housing including a removable first handle and a removable second handle, a display configured to display images captured by the image capture device in response to receiving the received digital data, and a user interface overlaid over the displayed images, the user interface including touchscreen icons.

In another aspect, the disclosure provides a cable for use with a pipeline inspection device. The cable includes a monitoring device including a housing having a removable first handle and a removable second handle, a display configured to display images captured by an image capture device, and a user interface overlaid over the displayed images, the user interface including a home screen having touchscreen icons configured to allow a user to capture, edit, and send photos and videos via the image capture device.

In another aspect, the disclosure provides a monitoring device for use with a pipeline inspection system. The monitoring device includes a housing having a removable first handle and a removable second handle, a display configured to display images captured by an image capture device, and a user interface overlaid over the displayed images. The user interface includes touchscreen icons including a camera icon, a video icon, and a camera view icon, wherein the camera icon is configured to cause the monitoring device to capture a photo of the image on the display. The video icon is configured to cause the monitoring device to capture a video of the image on the display, and the camera view icon is configured to change a view displayed on the display.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”).

As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors.

Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 is an illustration of a pipeline inspection device, according to some aspects and examples.

FIG. 2 is a detailed illustration of a display device for use with the pipeline inspection device of FIG. 1, according to some aspects and examples.

FIG. 3 is a detailed illustration of a display device for use with the pipeline inspection device of FIG. 1, according to some aspects and examples.

FIG. 4 is a detailed illustration of a display for use with the display device of FIG. 3, according to some aspects and examples.

FIG. 5 is a detailed illustration of a slider for use with the display of FIG. 4, according to some aspects and examples.

FIG. 6 is a detailed illustration of a display for use with the display device of FIG. 3, according to some aspects and examples.

FIG. 7 is a detailed illustration of a slider for use with the display of FIG. 6, according to some aspects and examples.

FIG. 8 is a detailed illustration of a display for use with the display device of FIG. 3, according to some aspects and examples.

FIG. 9 is a detailed illustration of a display for use with the display device of FIG. 3, according to some aspects and examples.

FIG. 10 is a detailed illustration of a display for use with the display device of FIG. 3, according to some aspects and examples.

FIG. 11A is a detailed illustration of a display for use with the display device of FIG. 3, according to some aspects and examples.

FIG. 11B is a detailed illustration of a display for use with the display device of FIG. 3, according to some aspects and examples.

FIG. 12A is a detailed illustration of a settings screen for use with the display device of FIG. 3, according to some aspects and examples.

FIG. 12B is a detailed illustration of a settings screen for use with the display device of FIG. 3, according to some aspects and examples.

FIG. 13 is a detailed illustration of a display for use with the display device of FIG. 3, according to some aspects and examples.

FIG. 14 is a detailed illustration of an auto-hide feature for use with the display device of FIG. 3, according to some aspects and examples.

FIG. 15 is a detailed illustration of a display for use with the display device of FIG. 3, according to some aspects and examples.

FIG. 16 is a detailed illustration of a settings screen for use with the display device of FIG. 3, according to some aspects and examples.

FIG. 17A is a detailed illustration of a gallery view for use with the display device of FIG. 3, according to some aspects and examples.

FIG. 17B is a detailed illustration of a gallery view for use with the display device of FIG. 3, according to some aspects and examples.

FIG. 18 is a detailed illustration of a detailed view for use with the display device of FIG. 3, according to some aspects and examples.

FIG. 19A is a detailed illustration of an editing mode for use with the display device of FIG. 3, according to some aspects and examples.

FIG. 19B is a detailed illustration of an editing mode for use with the display device of FIG. 3, according to some aspects and examples.

FIG. 20 is a detailed illustration of a drawing mode for use with the display device of FIG. 3, according to some aspects and examples.

FIG. 21A is a detailed illustration of an editing mode for use with the display device of FIG. 3, according to some aspects and examples.

FIG. 21B is a detailed illustration of an editing mode for use with the display device of FIG. 3, according to some aspects and examples.

FIG. 22A is a detailed illustration of an editing mode for use with the display device of FIG. 3, according to some aspects and examples.

FIG. 22B is a detailed illustration of an editing mode for use with the display device of FIG. 3, according to some aspects and examples.

FIG. 22C is a detailed illustration of an editing mode for use with the display device of FIG. 3, according to some aspects and examples.

FIG. 23 is a detailed illustration of sorting view for use with the display device of FIG. 3, according to some aspects and examples.

FIG. 24 is a detailed illustration of a gallery view for use with the display device of FIG. 3, according to some aspects and examples.

FIG. 25 is a detailed illustration of a gallery view for use with the display device of FIG. 3, according to some aspects and examples.

FIG. 26 is a detailed illustration of a display for use with the display device of FIG. 3, according to some aspects and examples.

FIG. 27A is a detailed illustration of a display for use with the display device of FIG. 3, according to some aspects and examples.

FIG. 27B is a detailed illustration of a display for use with the display device of FIG. 3, according to some aspects and examples.

### DETAILED DESCRIPTION

Before any embodiments are explained in detail, it is to be understood that embodiments are not limited in their application to the details of construction and the arrangement of components set forth in the following description or illustrated in the following drawings. Other embodiments are possible and embodiments described and illustrated are capable of being practiced or of being carried out in various ways. A pipeline inspection device is an apparatus that inspects the interior of pipelines to identify any damages or defects. The device may include image capture devices, cameras, sensors, navigation systems, data storage, and communication systems. The image capture device may capture images of the inside of the pipe, while sensors collect data about the conditions within. Navigation systems help the device operator track the device's location, and data storage allows the operator to review and analyze the data. Communication systems enable the device to transmit data to a control center or remote operator. Examples and embodiments described herein relate to display devices for use with a pipeline inspection device. In some examples, the display device may be useable with a borescope to allow for captured images to be displayed thereon. Additionally or alternatively, the display device may directly attach to a borescope camera. In some instances, the display device is directly coupled to an image capture device, allowing an operator to use the display device to examine an area.

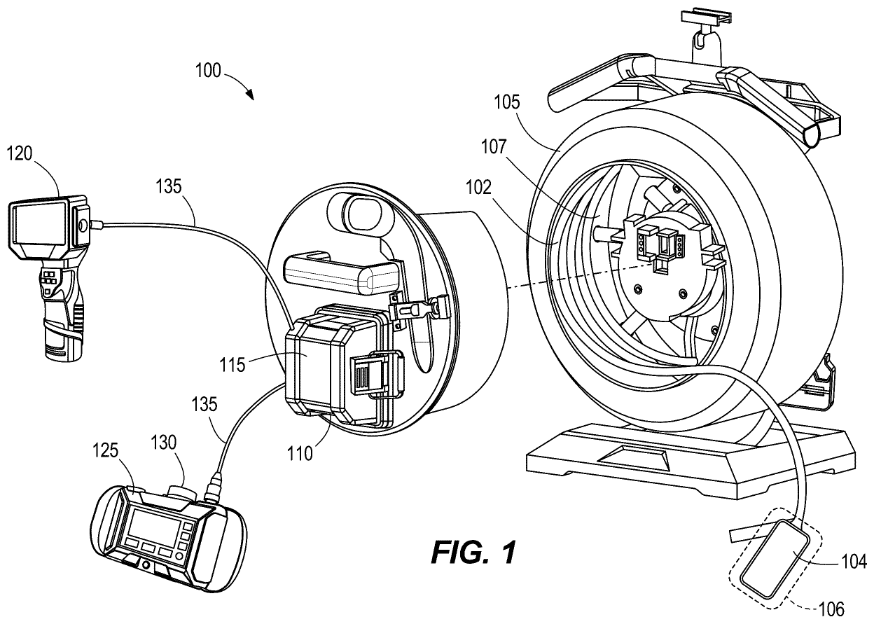

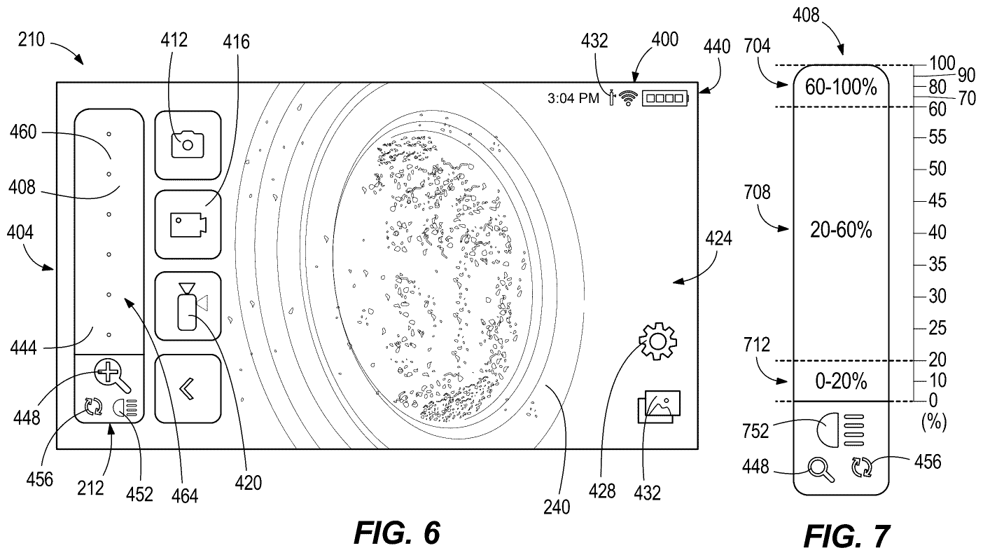

FIG. 1 illustrates a pipeline inspection device 100 including a reel housing 105 and a push cable 102 with an image capture device 104, also referred to as a camera, connected to the push cable 102. In some examples, the push cable 102 may be referred to as an inspection cable. The push cable 102 is stored on a reel 107 within the reel housing 105 such that that the push cable 102 may be wound and unwound (i.e., spooled and unspooled) as needed by an operator of the pipeline inspection device 100. In some instances, the image capture device 104 is detachably connected to the push cable 102, such that multiple image capture devices may be interchangeably connected and disconnected from the push cable 102. The image capture device 104 is illustrated in FIGS. 5-7 and described in greater detail below.

The pipeline inspection device 100 also includes a hub 110. The hub 110 includes a battery receptacle that selectively receives a battery pack (e.g., a power tool battery pack) to power the pipeline inspection device 100. The hub 110 also includes electronics, such as an image processor and/or a wireless transceiver, to control operation of the pipeline inspection device 100. The hub 110 is configured to connect to a display, such as a tablet, smartphone, laptop, or similar device configured to display images captured by the image capture device 104. The pipeline inspection device 100 also includes an input/output interface 115 configured to electrically communicate with handheld devices, such as image capture device 104, a handheld controller 120, and a monitor, also referred to as display device 125. However, in other examples, the handheld controller 120 may be coupled directly to the image capture device 104 via the push cable 102. In some instances, the handheld devices are battery powered. For example, handheld controller 120 and/or the display device 125 may be powered by a detachable, rechargeable battery pack 130. In other instances, display device 125 connects to the input/output interface 115 by way of a cable 135, where the cable is configured to provide power and enable communication between the display device 125 and the pipeline inspection device 100. For example, the cable 135 may include a USB-C connector enable electrical communication between the connected devices. In other instances, display device 125 connects to the pipeline inspection device 100 wirelessly via a near field communication (NFC) connection, a short-range wireless connection (for example, a Bluetooth® connection), an IEEE 802.11 protocol connection (for example, Wi-Fi), or the like.

In some instances, the image capture device 104 includes a removable cover 106 (referred to as cover 106) configured to protect the image capture device 104. The cover 106 is configured to protect the image capture device 104 as it passes through a pipe. For example, old pipes often require a relining procedure that includes releasing a resin within the pipe and solidifying the resin with a UV light. During this process, the resin may coat the lens of an uncovered image capture device, thereby damaging or destroying the image capture device. However, by including a removable and disposable cover 106, the image capture device 104 may be protected from damage during use.

In some examples, the cover 106 is molded out of polycarbonate and may include two pieces joined together to enclose and cover the image capture device 104. In other examples, a silicone tube or sleeve is provided together or as separate piece from the cover 106, where the silicone tube additionally covers a portion of the cable used for relining pipes. In some examples, the cover 106 may be configured to be disposable. However, in other examples, the cover may be configured to be reusable.

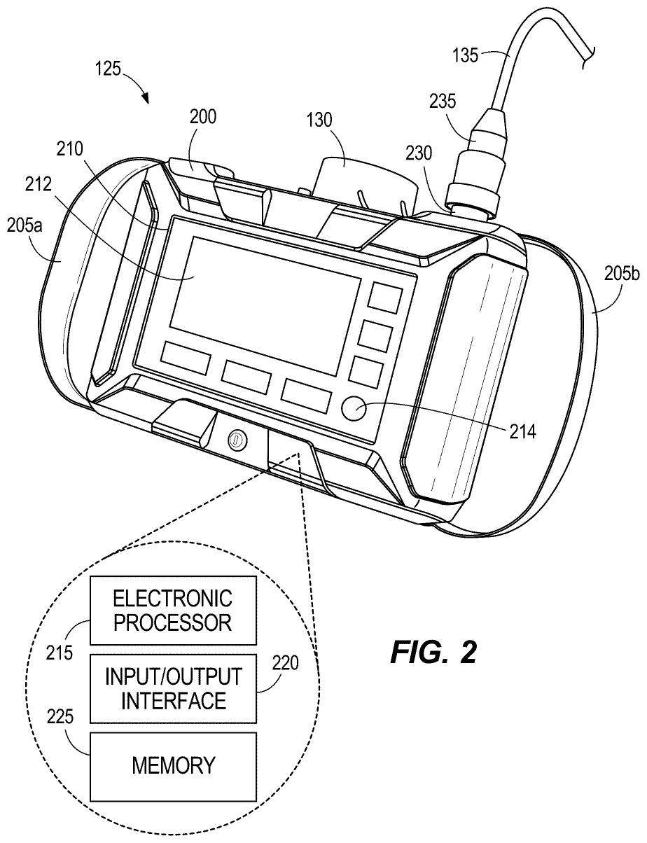

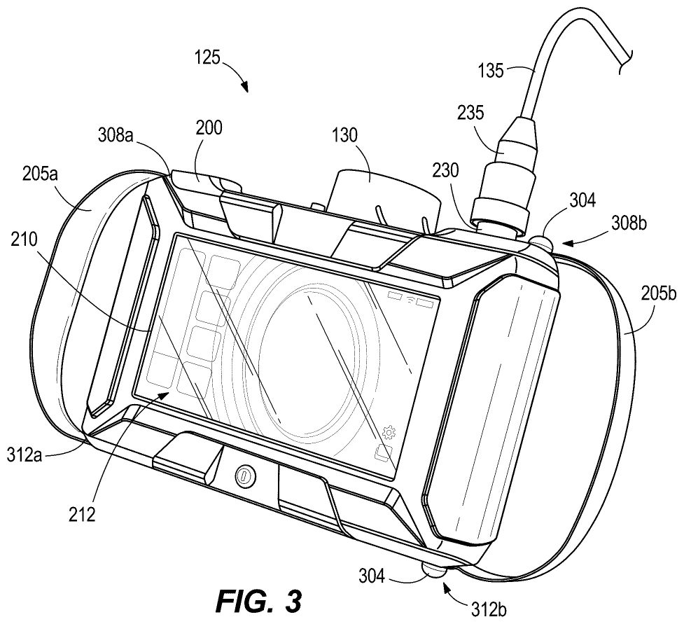

FIGS. 2 and 3 are illustrations of the display device 125 described above, according to some aspects and examples. The display device 125 may also be called a borescope or part of a borescope. The display device 125 includes a housing 200. The display device 125 also includes a display 210 for viewing an image or video 240 captured by the image capture device 104. The display 210 also includes a user interface 212 for controlling an image capture device, such as image capture device 104, configuring a setting of the image capture device or of the display 210, configuring a wirelessly connected device, or setting other features of the display device 125 and/or devices coupled to the display device. The housing 200 includes handles 205 such that the operator of the display device 125 may securely hold the display device 125. In the present embodiment, the housing 200 includes a first handle 205a and a second handle 205b. The first handle 205a and the second handle 205b may be removable to allow for a user to hold the display device 125 with either hand. In one example, the first handle 205a is secured to the display device 125 by pins 304 which are received by holes included on a first end 308a and a second end 312a of the first handle 205a and the second handle 205b is secured to the display device 125 by pins 304 which are received by holes included on a first end 308b and a second end 312b of the second handle 205b. However, other connection types, such as friction connections, slot-type connections, magnetic connection, and/or other connection types as required for a given application are also considered. The handles 205 therefore allow the user to hold the display device 125 with one hand and control the image capture device 104 with the other hand.

The user interface 212 may include a number of inputs 214 (e.g., push buttons, soft keys, touch screen icons, etc.) configured to allow the operator to control one or more aspects of the display device 125 and/or a connected device, such as controlling the settings of the display 210, the image capture device 104, or features of other connected devices, such as the pipeline inspection device 100, a connected imaging device (see below), or other component as required for a given application. In some instances, the display 210 includes a resolution of 720×1280 pixels. However, in display resolutions of more than 720×1280 pixels or less than 720×1280 pixels are also contemplated as required for a given application.

With reference to FIG. 2, in some instances, the display device 125 also includes an electronic processor 215, an input/output interface 220, and a memory storage 225. In some examples, the electronic processor 215 is implemented as a microprocessor with separate memory, for example the memory storage 225. In other examples, the electronic processor 215 may be implemented as a microcontroller (with memory storage 225 on the same package). In other examples, the electronic processor 215 may be implemented using multiple processors. In addition, the electronic processor 215 may be implemented partially or entirely as, for example, a field-programmable gate array (FPGA), an applications specific integrated circuit (ASIC), and the like and the memory storage 225 may not be needed or be modified accordingly. In some examples, the memory storage 225 includes non-transitory, computer-readable memory that stores instructions that are received and executed by the electronic processor 215 to carry out methods described herein.

The memory storage 225 may include, for example, a program storage area and a data storage area. For instance, programs for processing images captured by the image capture device 104 of the pipeline inspection device 100 may be stored in the memory storage 225. The memory storage 225 may include embedded multimedia card (eMMc) memory for storing associated programs/firmware, etc. However, other memory types are also contemplated as required for a given application. In some instances, the captured and processed images may be saved to another location or device, such as on a Micro SD card or other memory storage devices required for a given application. The program storage area and the data storage area may include combinations of different types of memory, for example read-only memory and random-access memory. The input/output interface 220 may include one or more input mechanisms and one or more output mechanisms (for example, general-purpose input/outputs (GPIOs), a network bus interface, analog inputs, digital inputs, Universal Serial Bus (“USB”) and others as required for a given application). The display device 125 includes a connection port 230 for electrically and mechanically interfacing with a connector 235 of the cable 135 to the display device 125. The connection port 230 may be, for example, a 6-pin keyed round connector. The connector 235 may be an associated 6-pin keyed round connector configured to interface with the connection port 230. However, other connection port and associated connector types are contemplated as required for a given application. The display device 125 also includes rechargeable battery pack 130 as previously described.

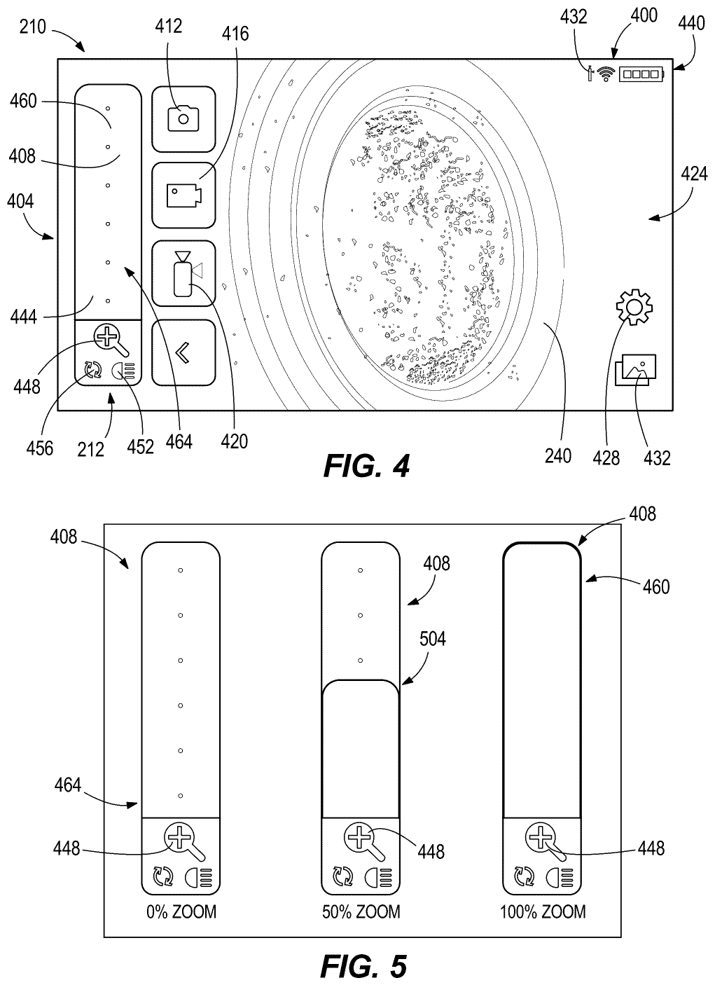

Referring to FIGS. 4-7, the display 210 includes a home screen 400 which has the user interface 212 overlaid over the image or video 240 captured by the image capture device 104. The user interface 212 includes several touchscreen icons on a first side 404 of the display 210. The icons include a variable slider 408, a camera icon 412, a video icon 416, and a camera view icon 420. The user interface 212 further includes several touchscreen icons on a second side 424 of the display 210. The icons include a settings icon 428 and a gallery icon 432. Lastly, the user interface 212 includes the time and a battery status icon 436 on a top corner 440. Each icon has an opacity of about 15% such that the image is visible behind the user interface 212. However, opacity values of more than 15% or less than 15% are also contemplated as required for a given application.

The variable slider 408 is configured to toggle between a zoom mode, a brightness mode, and a rotation mode. The variable slider 408 may be toggled between each mode by selecting a bottom portion 444 of the slider 408. The action of selecting, for example, may include tapping, pressing, toggling, etc. For example, selecting the bottom portion 444 where the slider is in brightness mode changes the slider to zoom mode, selecting the bottom portion 444 where the slider is in zoom mode changes the slider to rotation mode, and selecting the bottom portion 444 where the slider is in rotation mode changes the slider to brightness mode. The bottom portion 444 includes a zoom icon 448, a brightness icon 452, and a rotation icon 456, corresponding to each respective mode. The icon 448, 452, 456 of whichever mode that is active is larger than the other two icons (e.g., where brightness mode is active, the brightness icon 452 is larger than the zoom icon 448 and the rotation icon 456). Where the user drags their finger up or down the variable slider 408, the slider 408 adjusts the currently active mode. Where brightness mode is active, a top section 704 of the slider 408 accounts for brightness values between 60% and 100%, a middle section 708 of the slider 408 accounts for brightness values between 20% and 60%, and a bottom section 712 of the slider 408 accounts for brightness values between 0% and 20% (FIG. 7). Where the rotate mode is active, dragging the slider 408 adjusts the rotation of the image. Where the user drags upward toward a top 460 of the slider 408, the image rotates clockwise to a maximum rotation of 90 degrees. In contrast, where the user drags downward toward a bottom 464 of the slider 408, the image rotates counterclockwise to a minimum rotation of 0 degrees. In response to the image being rotated within 5 degrees of a 45-degree increment, the image snaps to the 45-degree increment. Where the zoom is 0% and the rotation of the image is 0 degrees, the image is in a home position.

In some embodiments, on the home screen 400, the display 210 may be further rotated in response to the user pressing two fingers to the display 210 and revolving their fingers. Rotation may be initiated in response to rotation of the second finger exceeding 10 degrees from the first finger, otherwise the rotation action may be ignored. The slider 408 may update in response to the user rotating their fingers. For example, the rotation on the slider may update live as the two fingers revolve. Similarly, the user may zoom-in and zoom-out the display 210 by pressing two fingers to the display screen and spreading or pinching their fingers with respect to one another. Zooming may be initiated in response to the distance between the first and second fingers while being spread exceeding 3 mm. The slider 408 may update in response to the user spreading or pinching their fingers. For example, the zoom level shown on the slider may update live as the two fingers zoom in and zoom out. The user may also pan the image on the display 210 by pressing one finger to the display 210 and dragging their finger across the display 210. Panning may only be initiated in response to the distance from the location of the user's initial screen touch exceeding 3 mm, otherwise the pan action may be ignored. The user may return the image to the home position by double tapping one finger on the display 210. Double tapping constitutes tapping a first time and tapping a second time within 400 ms of the first tap. Alternatively, or additionally, where the image is in the home position already, double tapping may cause the image to zoom-in.

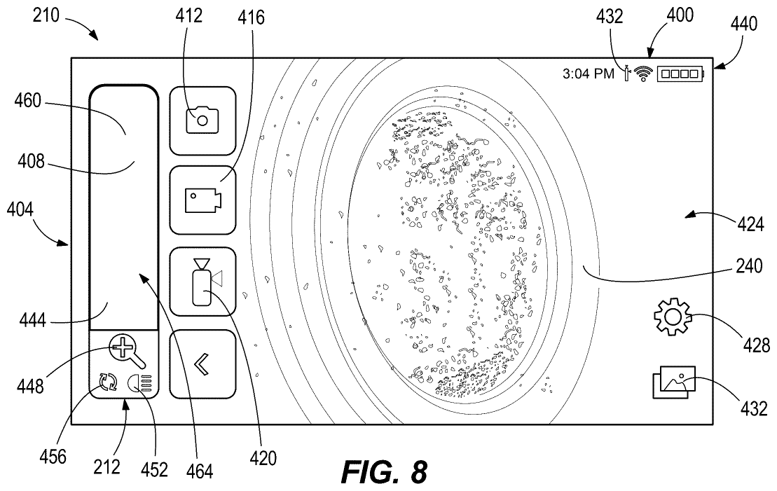

With reference to FIG. 8, the camera icon 412 is configured to capture a photo of the image 240 on the display 210 in response to the user selecting the camera icon 412. In response to the user selecting the camera icon 412, the opacity of the camera icon 412 increases to 45% opacity for 0.5 seconds. Next, the display 210 turns black for 0.2 seconds. Lastly, the gallery icon 432 briefly bulges to signify that the captured photo was saved to a gallery.

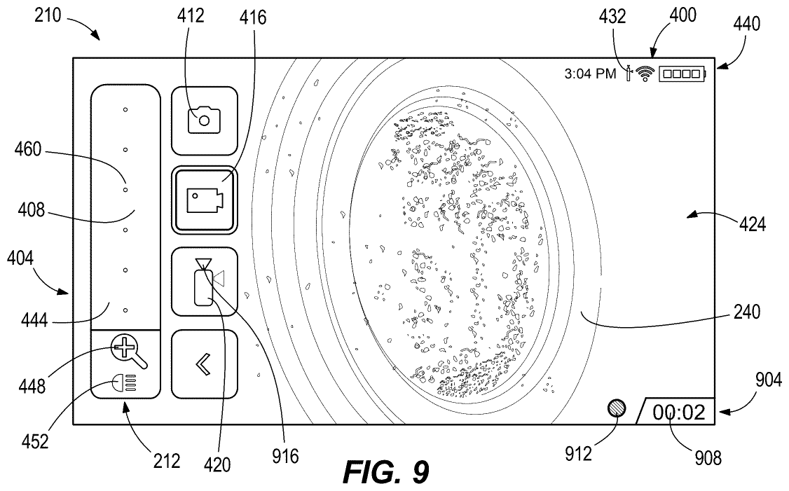

With reference to FIG. 9, the video icon 416 is configured to capture a video of the video 240 captured by the image capture device 104. In response to the user selecting the video icon 416, the video icon 416 turns red to signify an active video state and a video recording begins. Additionally, the settings icon 428, the gallery icon 432, the time, and the battery status icon 436 disappear during the active video state. A bottom right corner 904 of the display 210 displays a time elapsed 908 and a blinking red dot 912. The blinking red dot 912 flashes at 1 hz. The time elapsed 908 is measured from the moment the video icon 416 is tapped by the user to enter the active video state. To stop the video recording, the user taps the video icon 416 a second time. In response to the video icon 416 being tapped by the user a second time, the video icon 416 returns to its original state prior to the active video state. Additionally, the time elapsed disappears from the display 210 and the settings icon 428, the gallery icon 432, the time, and the battery status icon 436 return to the display 210. Lastly, the gallery icon 432 briefly bulges to signify that the captured video was saved to the gallery. In response to the time elapsed 908 reaching 29 minutes and 60 seconds, the video recording automatically stops and the video is saved to the gallery as described above.

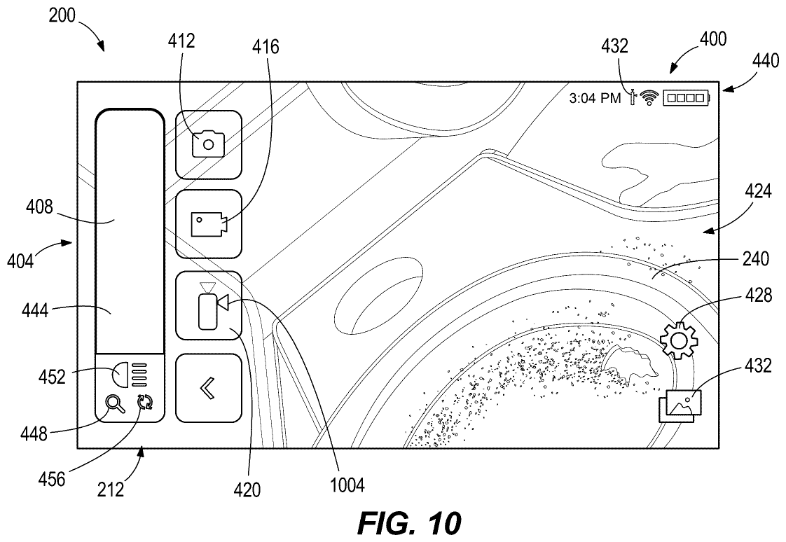

With reference to FIG. 10, the image capture device may capture several different views. Only one of the views captured by the image capture device may be showing on the display 210 at one time. The camera view icon 420 is configured to control which camera view is displayed on the display 210. For example, in response to the user tapping the camera view icon 420, the image on the display 210 changes to a different image from a different camera view. For example, in the present embodiment, the image capture device captures a front view and a side view. Where an image from the front view is displayed, the camera view icon 420 includes a triangle 916 pointing downward. Where an image from the side view is displayed, the camera view icon 420 includes a triangle 1004 pointing leftward. Therefore, pressing the camera view icon 420 while the side view is displayed causes the display to change and display the front view. In some embodiments, where the camera view is changed, a text briefly appears next to the icon to denote what view is being switched to (e.g., in response to the view being changed from the side view to the front view, the text briefly shows as “front”). In alternate embodiments, the image capture device 104 may only capture one view.

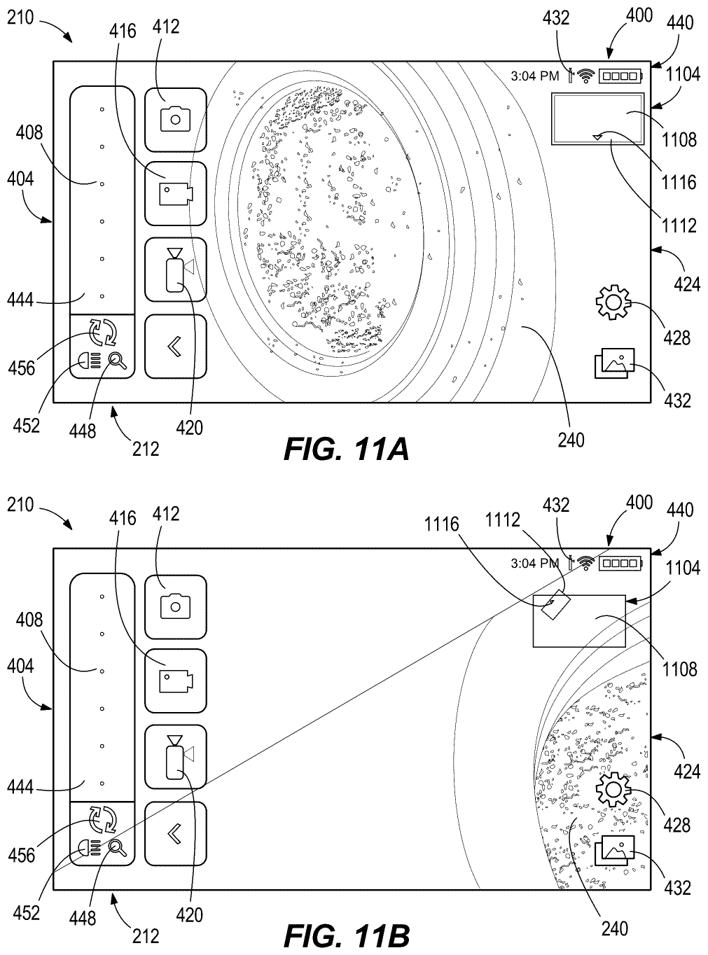

With reference to FIGS. 11A and 11B, in response to a rotate or zoom action occurring (either via the slider 408 or via the user using their fingers), a mini-map 1104 appears in the upper-right corner of the display 210 below the time and battery status icon 436. The mini-map 1104 is configured to remain visible on the display 210 until the image returns to the home position. The mini-map 1104 includes a bounds box 1108 and a view box 1112. The bounds box 1108 represents bounds of the image and the view box 1112 represents the current view of the image shown on the display 210. In other words, as the user rotates and/or zooms the image, the view box 1112 moves to show the current view of the image. The view box 1112 further includes an arrow 1116 which denotes the orientation of the image. For example, as shown in FIG. 11A, where the image is rotated 180 degrees, the arrow 1116 points down to represent that the image is now upside-down. Zooming in from 0% zoom, causes the view box 1112 to decrease in size within the bounds box 1108. For example, FIG. 11B shows an arrangement of the mini-map 1104 in which the view box 1112 is arranged in a top left corner of the bounds box 1108. The arrow 1116 is pointing diagonally toward the top left corner. This arrangement signifies that the display 210 displaying a zoomed-in view of a top portion of the image. In the present embodiment, the bounds box 1108 is white and the view box 1112 is red to allow the user to easily distinguish between the view box 1112 and the bounds box 1108. In other embodiments, the bounds box 1108 and the view box 1112 may be any of a number of different colors. In some embodiments, the display device 125 may include an accelerometer configured to determine an orientation of the display device 125.

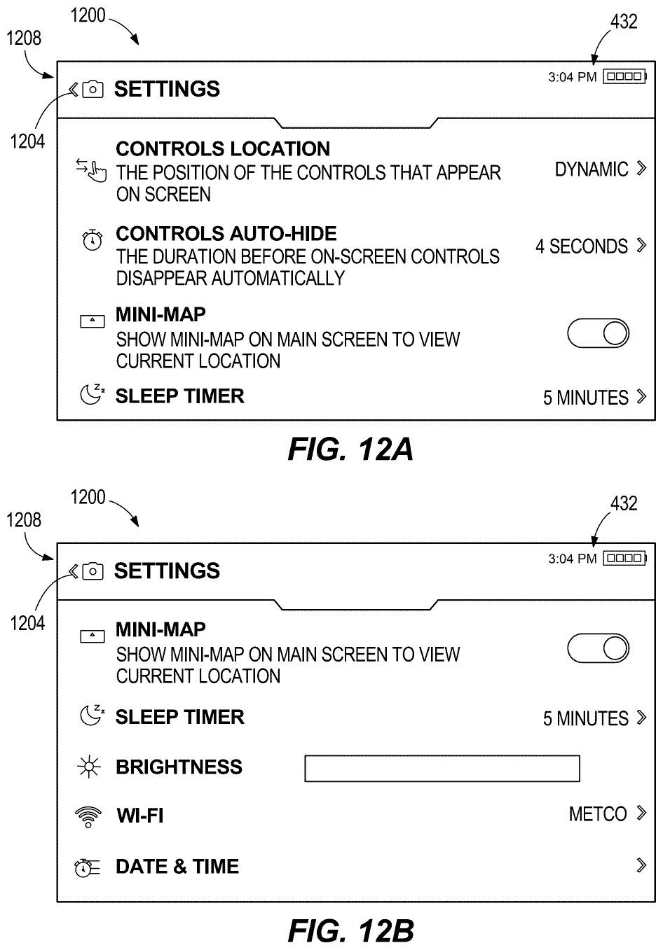

In response to the user selecting the settings icon 428, the display 210 will change from the home screen 400 to a settings screen 1200. The settings screen 1200 displays the time and battery level status icon 436 similar to the home screen 400. The settings screen 1200 allows the user to adjust a plurality of settings. As shown in FIGS. 12A-12B, the settings may include but are not limited to: controlling location of the user interface 212, controlling autohide of the user interface 212, toggling a mini-map, setting a sleep timer, adjusting the brightness of the display, connecting the display device to WI-FI (i.e., an internet connection), and adjusting the date and time. In some instances, the display device 125 may not connect to WI-FI or internet. To return to the home screen 400, the user may select a home icon 1204 which is located in a top left corner 1208 of the display.

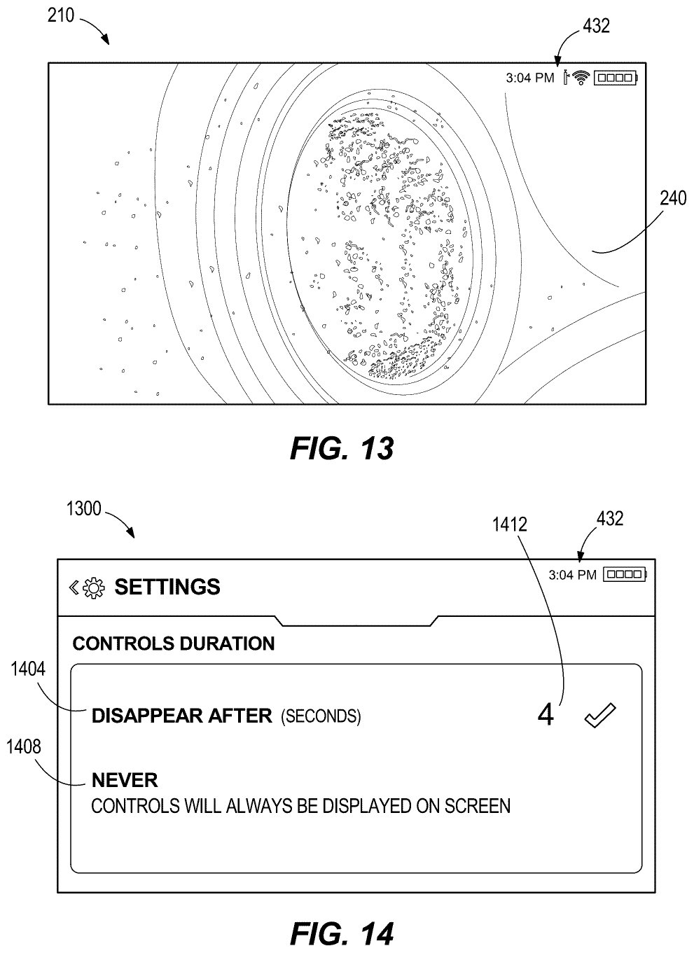

In the embodiment shown in FIGS. 13-14, the user may activate an auto-hide feature 1300 in the settings. The auto-hide feature 1300 may control the user interface to disappear after a certain period of time. In the settings, the user may tap on the auto-hide feature 1300 which opens a screen that permits the user to choose between a disappear after mode 1404 and a never mode 1408. The disappear after mode 1404 keeps a portion of the user interface on the display for only a period of time. The portion of the user interface which disappears include the variable slider 408, the camera icon 412, the video icon 416, the camera view icon 420, the settings icon 428, and the gallery icon 432. The time and battery status icon 436 always remain on the display 210. In response to the user choosing the disappear after mode 1404, the user may set the period of time by entering an amount of seconds in a user input box 1412. The amount of seconds determines the period of time that will elapse before the portion of the user interface 212 disappears. After choosing the disappear after mode 1404, a timer corresponding to the amount of seconds entered by the user will begin once the user returns to the home screen 400.

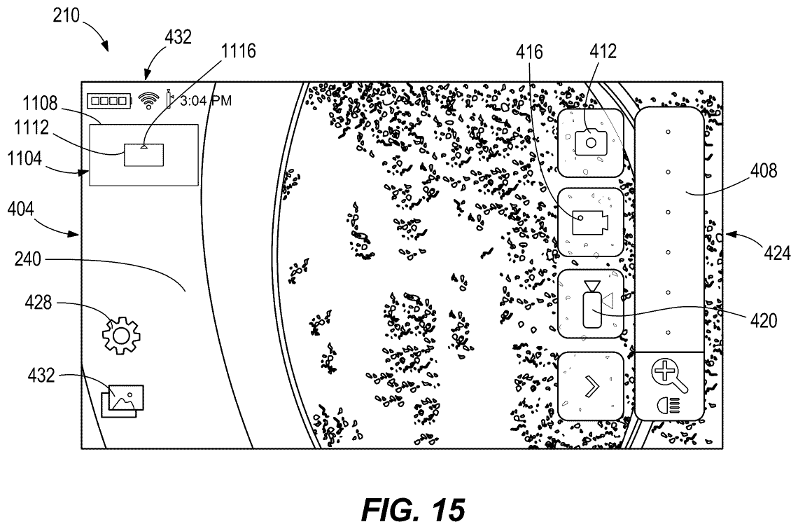

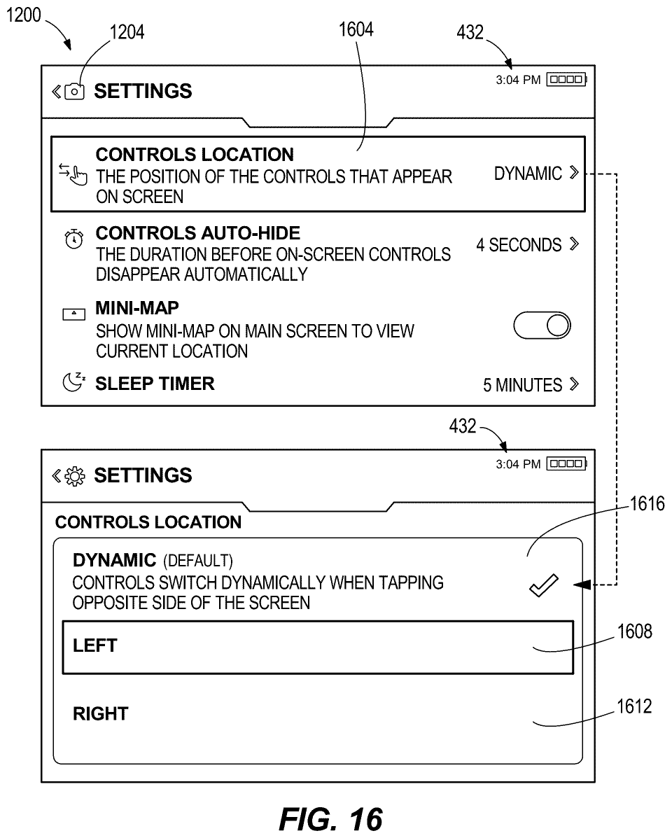

With reference to FIGS. 15 and 16, the user may adjust the location of the user interface 212 on the home screen 400. In the settings, the user may tap on a “controls location” feature 1604. Selecting on the “controls location” feature 1604 opens a screen that permits the user to choose between a “Left” mode 1608, a “Right” mode 1612, and a “Dynamic” mode 1616. In the “Left” mode 1608, the variable slider 408, the camera icon 412, the video icon 416, and the camera view icon 420 are on the first side 404, and the settings icon 428 and the gallery icon 432 are on the second side. In the “Right” mode 1612, the variable slider 408, the camera icon 412, the video icon 416, and the camera view icon 420 are on the second side 424, and the settings icon 428 and the gallery icon 432 are on the first side. In the “Dynamic” mode 1616, the location of the user interface 212 may be changed by tapping the opposite side of the display 210. For example, where the variable slider 408, the camera icon 412, the video icon 416, and the camera view icon 420 are on the second side 424, and the settings icon 428 and the gallery icon 432 are on the first side, selecting the first side 404 of the display 210 causes the user interface 212 to change such that the variable slider 408, the camera icon 412, the video icon 416, and the camera view icon 420 are on the first side 404, and the settings icon 428 and the gallery icon 432 are on the second side. By default, the display device is in the “Left” mode 1608. In use, the “controls location” feature 1604 allows the user to adjust the location of the user interface 212 based on how the user is holding the display device 125. For example, the user can adjust the user interface 212 such that the user's dominant hand can easily reach the icons and work the image capture device 104. A left-handed user may prefer the “Left” mode and a right-handed user may prefer the “Right” mode.

In response to the user selecting the gallery icon 432, the display 210 will change from the home screen 400 to a gallery view 1700. The gallery view 1700 displays the time and battery status icon 436 similar to the home screen 400. The gallery view 1700 displays the images and videos 240 captured by the user. To return to the home screen 400, the user may press the home icon 1204 which is located in a top left corner of the display 210.

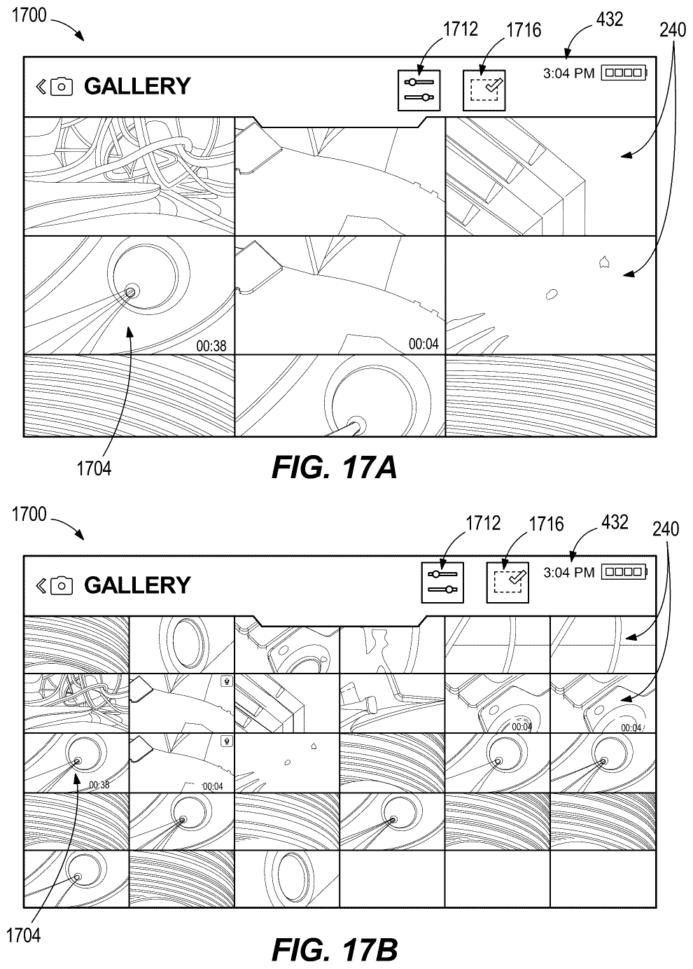

With reference to FIGS. 17A and 17B, the gallery view 1700 displays a grid 1704 of the captured images and videos 240. A length of the captured video 240 is overlaid on the videos 240 to depict how long the captured video is. By default, the images and videos 240 are sorted by date and the grid 1704 is 5 images or videos wide. The user may increase or decrease the size of the images and videos 240 in the grid by pinching or spreading two fingers. In the present embodiment, pinching two fingers decreases each image or video 240 size, thereby increasing the amount of images or videos 240 in each row (FIG. 17B). Spreading two fingers increases each image or video 240 size, thereby decreasing the amount of images or videos 240 in each row (FIG. 17A). In alternate embodiments, pinching two fingers may increase each image or video 240 size and spreading two fingers may decrease each image or video 240 size. In the present embodiment, the largest image or video 240 size in the grid 1704 is 3 images wide and the smallest image or video 240 size in the grid 1704 is 6 images wide. In other embodiments, other sizes may be contemplated.

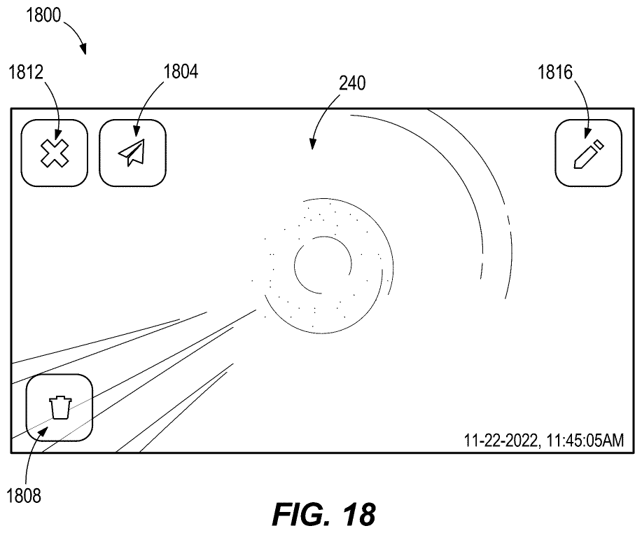

While on the gallery view 1700, selecting one of the captured images and videos 240 in the grid opens a detailed view 1800 of the captured image or video 240. The detailed view 1800 shows the captured image or video 240 full-screen on the display 210 (FIG. 18). The detailed view 1800 includes the send icon 1804 and the trash icon 1808. The detailed view 1800 further includes a close icon 1812. Selecting the close icon 1812 allows the user to exit the detailed view 1800 and re-enter the gallery view 1700. Lastly, the detailed view 1800 includes an edit icon 1816 which allows the user to edit the image or video 240.

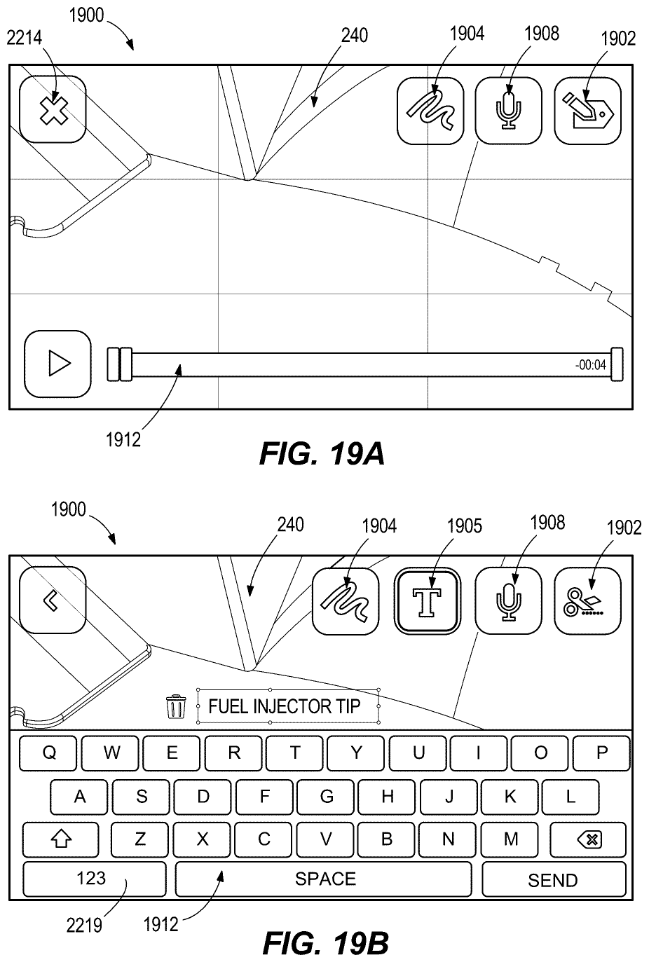

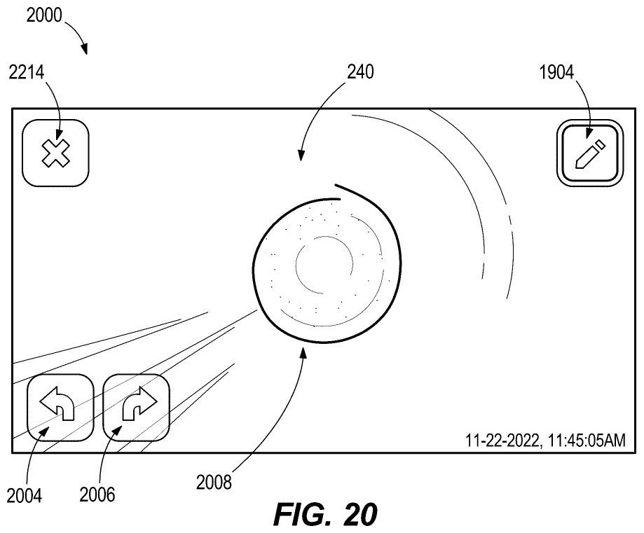

With reference to FIG. 19A, in response to the user tapping the edit icon 1816, the display device 125 enters an editing mode 1900. In the editing mode 1900, a draw icon 1904 appears. In response to the user pressing on the draw icon 1904, the display device 125 enters a drawing mode 2000 (FIG. 20) which allows the user to draw on the captured image or video 240. In response to the display device 125 entering the drawing mode 2000, all other icons disappear and only the full screen image or video 240, the draw icon 1904, an undo icon 2004, and a redo icon 2006 are visible. In response to the user tapping and dragging their finger on the screen, a line 2008 is drawn on the image or video 240. Multiple lines 2008 may be drawn. After at least one line 2008 has been drawn, the undo icon 2004 becomes active. Pressing the undo icon 2004 reverts the most recent change. After the undo icon 2004 is pressed, the redo icon 2006 becomes active. Pressing the redo icon 2006 restores the most recently reverted changes. Pressing the undo icon 2004 multiple times reverts multiple changes until there are no longer any changes to revert. After finishing drawing on the image or video 240, the user may select the draw icon 1904 to return to the editing mode 1900 with the new drawings embedded within the image or video 240. On videos, drawings are present for 5 seconds, then the drawings disappear. Multiple drawings may be added within a video at different times. The user may utilize the drawing mode 2000 to identify certain aspects of note within the video or image 240.

With reference to FIG. 19B, in the editing mode 1900, a text icon 1905 may also appear. In response to the user pressing the text icon 1905, a customizable text box 1906 populates on the screen along with a keyboard 2219, which allows the user to overlay text on the captured image or video 240. The text box 1906 is moveable within the bounds of the image or video 240 in response to the user tapping on the text box 1906 and dragging their finger on the screen 400. Multiple text boxes 1906 may be added. On videos, the text boxes 1906 are present for 10 seconds, then the text boxes 1906 disappear. Multiple text boxes 1906 may be added within a video at different times. The user may utilize the text box 1906 to identify certain aspects of note within the video or image 240.

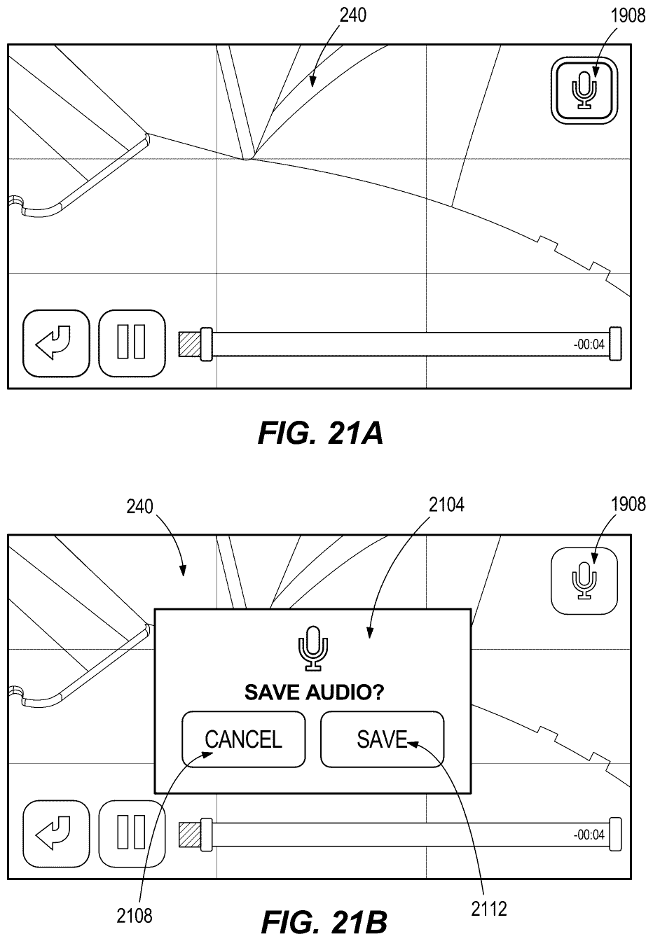

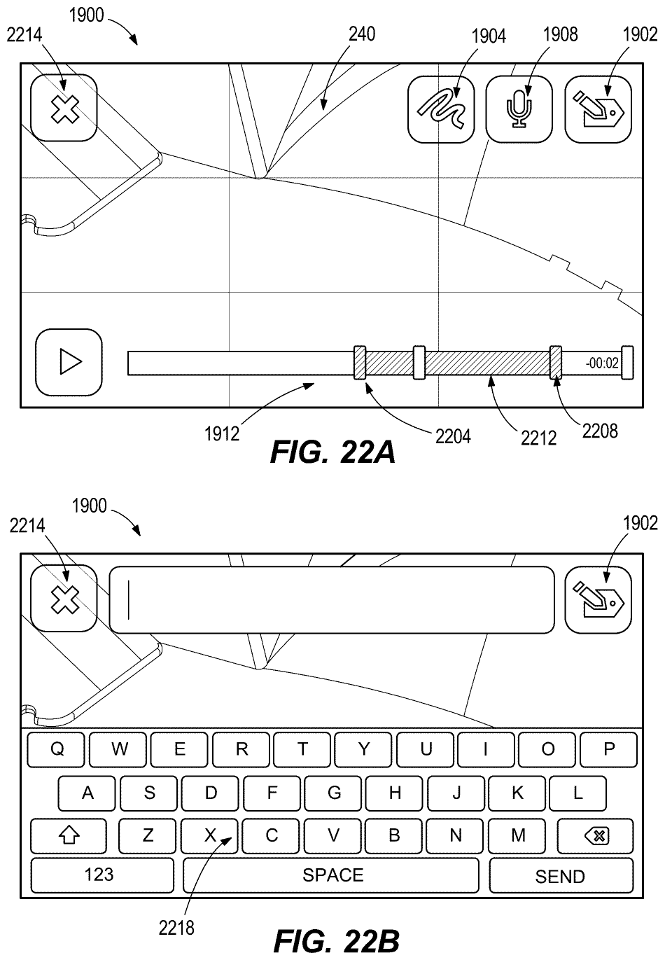

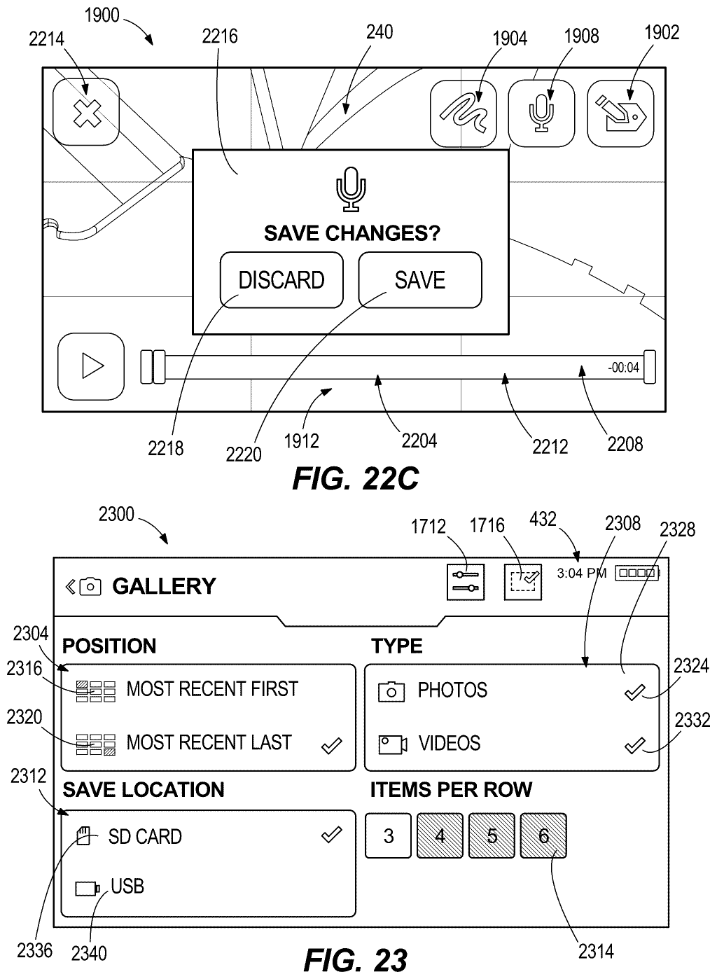

Videos in editing mode 1900 further include an audio record icon 1908 and video trimming controls 1912. With reference to FIGS. 21A-22B, in response to the user pressing on the audio record icon 1908, the display device 125 begins audio recording while the video plays back for the user. Tapping the audio record icon 1908 before the video playback finishes or waiting until the video playback completes brings up a save audio dialogue 2104. The save audio dialogue 2104 includes a cancel button 2108 and a save button 2112. Pressing the cancel button 2108 discards the recorded audio. Pressing the save button 2112 embeds the audio into the video. The video trimming controls 1912 include a first control 2204 which determines the starting point of the video and a second control 2208 which determines the ending point of the video. Both the first control 2204 and the second control 2208 can be dragged along a playback bar 2212 by tapping and dragging along the playback bar 2212 (FIG. 22A).

Lastly, the editing mode 1900 includes a filename icon 1902. In response to the user pressing on the filename icon 1902, the name of the image or video 240 may be changed (FIG. 22B). Selecting the filename icon 1902 brings up the keyboard 2219 and allows the user to edit the name of the image or video 240. In response to the name being too long, the name is configured to wrap to a second line. After the user is satisfied with their edits or the user wants to exit the editing mode 1900, the user may select an exit icon 2214. Pressing the exit icon 2214 brings up a “Save Changes” dialog box 2216 (FIG. 22C). The dialog box 2216 includes a discard button 2218 and a save button 2220. Pressing the save button 2220 saves all changes and returns to the detailed view 1800. Pressing the discard button 2218 deletes all changes, reverts the image/video 240 to the original, un-edited state, and returns to the detailed view 1800.

The gallery view 1700 further includes a sort icon 1712 and a select icon 1716 (FIG. 17A). With reference to FIG. 23, selecting the sort icon 1712 opens a sorting panel 2300. The sorting panel 2300 includes a plurality of sorting options. The sorting options include a position section 2304, a type section 2308, a save location section 2312, and an items per row section 2314.

The position section 2304 allows the user to decide between a most-recent first option 2316 and a most-recent last option 2320. Where the most-recent first option 2316 is selected, the captured photos and videos are organized in order from newest captured to oldest captured. Where the most-recent last option 2320 is selected, the captured photos and videos are organized in order from oldest captured to newest captured. Only one of the most-recent first option 2316 and the most-recent last option 2320 may be selected at one time and may never be active simultaneously. Where an option is active, a checkmark 2324 appears next to the option. By default, the most-recent last option 2320 is active.

The type section 2308 includes a photos option 2328 and a videos option 2332. Where the photos option 2328 is selected and active, the gallery grid 1704 includes all captured photos. Where the videos option 2332 is selected and active, the gallery grid 1704 includes all captured videos. Both the videos option 2332 and the photos option 2328 may be active or inactive simultaneously. Additionally, the videos option 2332 may be active where the photos option 2328 is inactive and vice versa. By default, the photos option 2328 and the videos option 2332 are both active.

The save location section 2312 includes an SD card option 2336 and a USB option 2340. The SD card option 2336 shows captured images and videos 240 saved in an internal SD card. The USB option 2340 shows captured images and videos 240 saved on an inserted USB device. Only one of the SD card option 2336 and the USB option 2340 may be selected at one time and may never be active simultaneously. In response to neither option being active, no images or videos show in the gallery. In response to a USB device not being inserted, the USB option 2340 is not present. Lastly, the items per row section 2314 allows the user to decide how many images or videos are included in each row of the grid 1704. The items per row section 2314 provides the user an alternative to pinching and zooming while on the gallery view 1700.

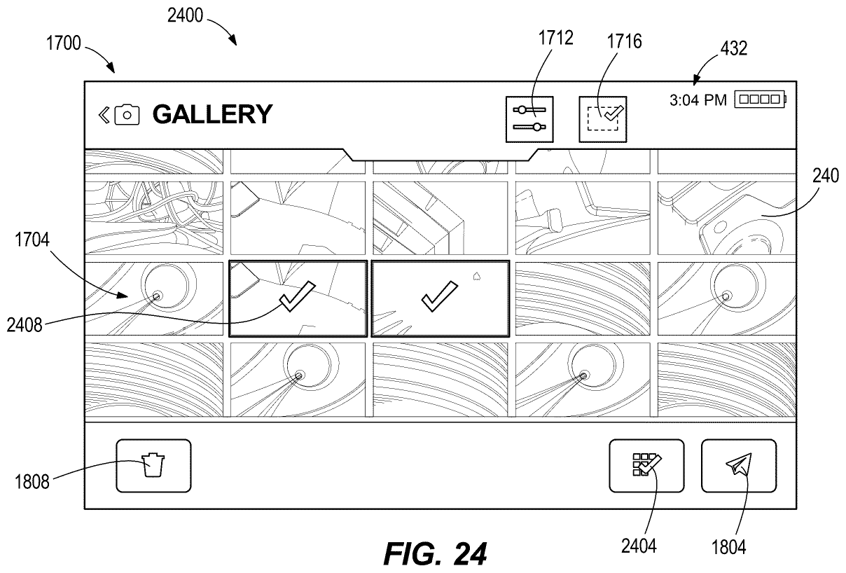

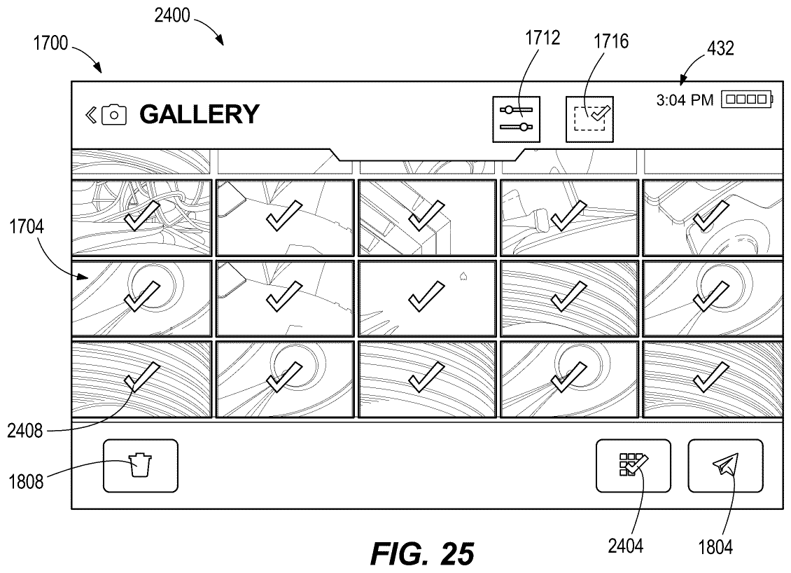

With reference to FIGS. 24 and 25, tapping the select icon 1716 in the gallery view 1700 opens a selection mode 2400. Where the display device 125 enters the selection mode 2400, the images and videos 240 in the grid 1704 are shrunk by 10% to allow room for the trash icon 1808, a select all icon 2404, and the send icon 1804. The selection mode allows the user to select any of the images or videos in the gallery. In response to an image or video 240 being tapped by the user, a white highlight and checkmark 2408 appears over the image to signify that the image or video 240 has been selected. The user may tap the image or video 240 again to deselect the image or video 240. Tapping the select all icon 2404 automatically selects all images or videos 240 in the gallery. Initially, the trash icon 1808 and the send icon 1804 are greyed out where no images or videos are selected. Once the user selects one image or video 240, the trash icon 1808 and the send icon 1804 become active. Pressing the trash icon 1808 where at least one image or video 240 has been selected deletes the selected images or videos from the display device 125.

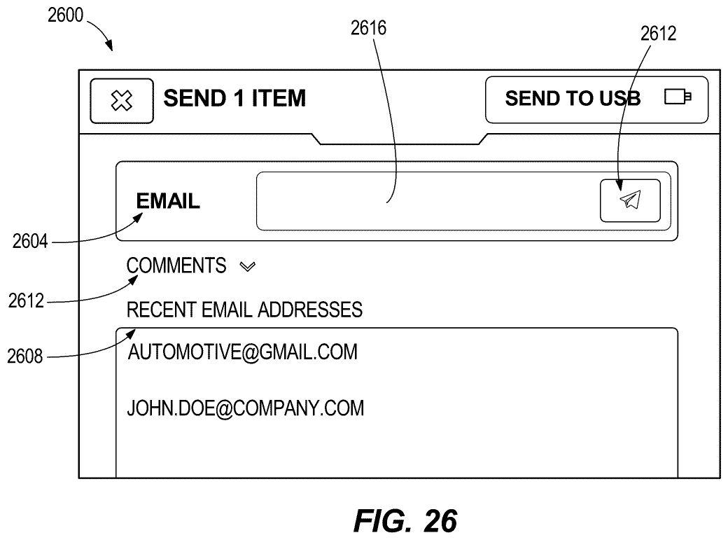

Pressing the send icon 1804 opens a send display 2600 which allows the user to send the selected images or videos to a chosen email (FIG. 26). The send display 210 includes an email input box 2604 which allows the user to enter an email of a recipient to receive the selected images or videos. The send screen further includes a comments section 2616 which allows the user to enter any comments to be sent to the recipient email with the selected images or videos. Lastly, the send display 210 displays recent email addresses 2608 which are the most recent email addresses that the user sent captured images or videos to. The user may choose one of the recent email addresses 2608 in lieu of entering an email in the email input box 2604. Lastly, the user may select the send email icon 2612 to send the selected images or videos 240 to the chosen email. In response to the selected images or videos being too large to send over email, the display device 125 may automatically create a link through which all selected images or videos 240 are stored and hosted on the cloud.

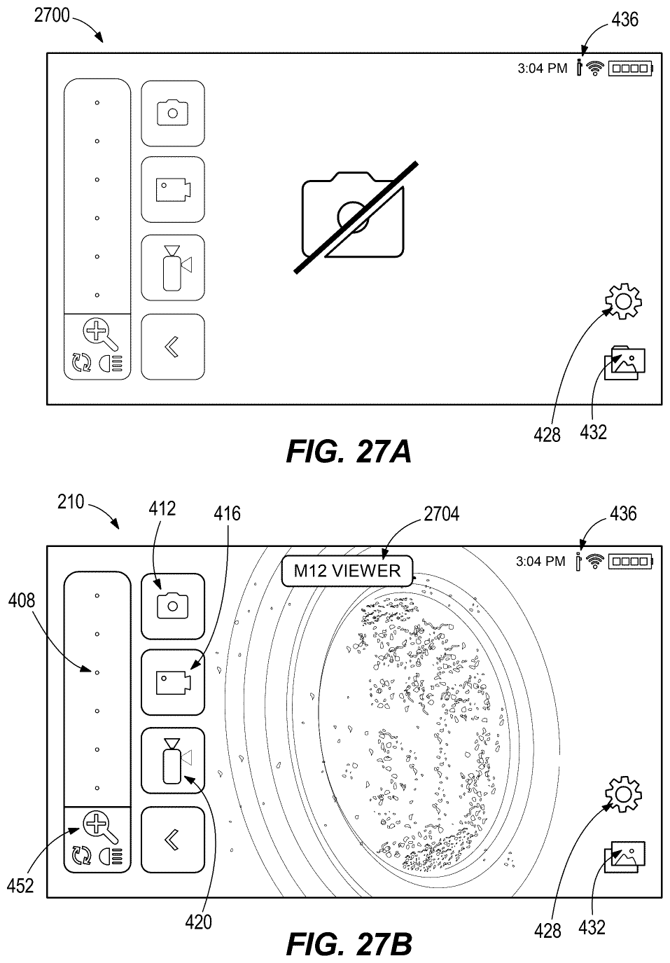

With reference to FIGS. 27A and 27B, the image capture device 104 may be connected and disconnected from the pipeline inspection device 100. Where the image capture device 104 is disconnected from the pipeline inspection device 100, an error screen 2700 shows and the icons visible on the home screen 400 are not available. Where the image capture device 104 is initially connected to the pipeline inspection device 100, a descriptor popup 2704 appears at the top of the display 210. The descriptor popup 2704 is configured to stay on the display for 5 seconds. The descriptor popup 2704 may show for example: “shop borescope”, “5 mm automotive camera”, “4′ 10 mm Plumbing Camera”, “10′ 10 mm Plumbing Camera”, “360 degree 8 mm Camera”, “FLEX Reel”, “M18 Inspection Camera”, or “M12 Inspection Camera”.

Alternatively, or additionally to the display device 125, the user may use a cellular device to view the images or videos captures by the image capture device 104. For example, the user may download an app to view the images or videos captures by the image capture device 104. In the present embodiment, the user interface 212 remains the same regardless of whether the user is using the display device 125 or the cellular device. The user interface 212 is configured to be compatible with iOS and Android to maintain a consistent user experience.

Accordingly, various implementations of the systems and methods described herein provide, among other things, a system of pipeline inspection. Other features and advantages of the invention are set forth in the following claims.

In the foregoing specification, specific examples have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

1. An inspection system, the system comprising:
a cable including:
an image capture device positioned at a distal end of the cable, wherein the image capture device is configured to output digital data; and
a monitoring device, the monitoring device including:
a housing including a removable first handle and a removable second handle,
a display configured to display images captured by the image capture device in response to receiving the received digital data,
a user interface overlaid over the displayed images, the user interface including touchscreen icons.

2. The system of claim 1, wherein the second handle is secured to the display device by pins received by holes included on a first end and a second end of the second handle.

3. The system of claim 1, wherein the handles are configured to permit the user to hold the display device with a first hand and control the image capture device with a second hand.

4. The system of claim 1, wherein the touchscreen icons include a variable slider, a camera icon, a video icon, and a camera view icon.

5. The system of claim 4, wherein the touchscreen icons further include a settings icon and a gallery icon.

6. The system of claim 5, wherein the setting includes a controls location feature configured to allow a user to adjust a location of the user interface based on how the user is holding the display device.

7. The system of claim 4, wherein the variable slider is configured to toggle between a zoom mode, a brightness mode, and a rotation mode.

8. The system of claim 4, wherein the camera icon is configured to cause the monitoring device to capture a photo of the image on the display.

9. The system of claim 4, wherein the video icon is configured to cause the monitoring device to capture a video of the image on the display.

10. The system of claim 4, wherein the image capture device includes a first camera view and a second camera view, the camera view icon configured to control which of the first camera view and the second camera view is displayed on the display.

11. A cable for use with a pipeline inspection device, the cable comprising:
a monitoring device, the monitoring device including:
a housing including a removable first handle and a removable second handle,
a display configured to display images captured by an image capture device, and
a user interface overlaid over the displayed images, the user interface including a home screen having touchscreen icons configured to allow a user to capture, edit, and send photos and videos via the image capture device.

12. The cable of claim 11, wherein the touchscreen icons include a gallery icon, a camera icon, and a video icon.

13. The cable of claim 12, wherein the camera icon is configured to cause the monitoring device to capture a photo of the image on the display, wherein the video icon is configured to cause the monitoring device to capture a video of the image on the display.

14. The cable of claim 13, wherein in response to the user selecting the gallery icon, the display changes from the home screen to a gallery view configured to display images and videos captured by the user.

15. The cable of claim 14, wherein in response to the user tapping the edit icon, the display device enters an editing mode including a draw icon configured to allow the user to draw on the captured image or video and a text icon configured to allow the user to overlay text on the captured image or video.

16. A monitoring device for use with a pipeline inspection system, the monitoring device comprising:
a housing including a removable first handle and a removable second handle;
a display configured to display images captured by an image capture device; and
a user interface overlaid over the displayed images, the user interface including touchscreen icons including a camera icon, a video icon, and a camera view icon,
wherein the camera icon is configured to cause the monitoring device to capture a photo of the image on the display, wherein the video icon is configured to cause the monitoring device to capture a video of the image on the display, and wherein the camera view icon is configured to change a view displayed on the display.

17. The monitoring device of claim 16, wherein in response to a rotate or zoom action occurring, a mini-map appears in an upper-right corner of the display.

18. The monitoring device of claim 17, wherein the mini-map includes a bounds box and a view box.

19. The monitoring device of claim 18, wherein the bounds box represents bounds of the displayed image and the view box represents a current view of the displayed image shown on the display.

20. The monitoring device of claim 17, further comprising an auto-hide feature which controls the user interface to disappear after a period of time.
